(19) United States
(12) Patent Application Publication
(10) Pub. No.: US 2014/0178636 A1
(43) Pub. Date: Jun. 26, 2014

(54) COMPOSITE MATERIAL AND METHOD OF FORMING THE SAME

(71) Applicants: Jung-Chin Wu, Taipei City (TW); Po-An Lin, Taipei City (TW); Han-Ching Huang, Taipei City (TW)

(72) Inventors: Jung-Chin Wu, Taipei City (TW); Po-An Lin, Taipei City (TW); Han-Ching Huang, Taipei City (TW)

(73) Assignee: COMPAL ELECTRONICS, INC., Taipei City (TW)

(21) Appl. No.: 14/105,185

(22) Filed: Dec. 13, 2013

Related U.S. Application Data
(60) Provisional application No. 61/740,426, filed on Dec. 20, 2012.

(51) Int. Cl. B32B 37/00; B32B 3/26

(52) U.S. Cl. CPC B32B 37/0023; B32B 3/266
USPC 428/140; 156/306.6

(57) ABSTRACT

Provided is a composite material including a first surface layer, a second surface layer, and a core layer. The first surface layer includes a first fiber material layer and a first resin impregnated therein. The second surface layer includes a second fiber material layer and a second resin impregnated therein. The core layer is disposed between the first surface layer and the second surface layer and has a plurality of through holes, wherein the first resin and the second resin penetrate into each of the through holes, combining with each other, and forming a connecting column in each of the through holes.

### CROSS-REFERENCE TO RELATED APPLICATION

This application claims the priority benefits of U.S. provisional application Ser. No. 61/740,426, filed on Dec. 20, 2012. The entirety of the above-mentioned patent applications is hereby incorporated by reference and made a part of this specification.

### BACKGROUND

1. Technical Field

The present invention is directed to a composite material, and more particularly, to a composite material for manufacturing the chassis of notebook, and a method of forming the same.

2. Description of Related Art

The computer has become an indispensable product for the majority of human beings due to its unique ability to store and compute large amounts of data. With the progress of the technology, the functions and speed of the computers have been continuously improved, and computer has evolved from the earlier bulky machinery to the desktop and notebook computers nowadays.

A primary object of the improvement of the notebook computers is the reduction of the weight and the volume. Micro-electronic elements in the computer are designed accordingly, and the material for the computer chassis is also selected in view of this requirement. The conventional notebook computers generally uses plastic as the chassis material. These materials have the advantages of low cost but are unsatisfactory in that when being thinned for the purpose of reducing volume and weight, the mechanical strength thereof is insufficient. Several designs have been proposed in response to this issue; for example, “ribbons” are added into the plastic chassis for reinforcement, or the chassis is manufactured by other novel materials such as glass fibers, carbon fibers, or composite material. However, with respect to computer chassis made from a composite material, the strength, weight, and cost thereof still looks for further improvement.

### SUMMARY

The present invention provides a composite material including a first surface layer, a second surface layer, and a core layer. The first surface layer includes a first fiber material layer and a first resin impregnated therein. The second surface layer includes a second fiber material layer and a second resin impregnated therein. The core layer is disposed between the first surface layer and the second surface layer and has a plurality of through holes, wherein the first resin and the second resin penetrate into each of the through holes, combining with each other, and forming a connecting column in each of the through holes.

In an embodiment, the thickness of the core layer is between 0.1 mm and 1 mm.

In an embodiment, apertures of each of the through holes are substantially the same, and the through holes are arranged in a hexagonal close-packed array in the core layer.

In an embodiment, the aperture of each of the through holes is greater than a thickness of the core layer.

In an embodiment, the pitch of the through holes is greater than the aperture of each of the through holes.

In an embodiment, the core layer includes a thermoplastic resin.

In an embodiment, the core layer includes polycarbonate (PC), polyethylene terephthalate (PET), polymethyl methacrylate (PMMA), polyethylene (PE), acrylonitrile-butadiene-styrene (ABS), polypropylene (PP), polystyrene (PS), polyamide (PA), a metal, an artificial fiber, or a natural fiber.

In an embodiment, the first fiber material layer and the second fiber material layer respectively include a carbon fiber, a glass fiber, an artificial fiber, or a natural fiber.

The present invention further provides a method of forming a composite material including the following steps. A core layer is provided, wherein the core layer has a first surface and a second surface opposite to each other and a plurality of through holes each extending from the first surface to the second surface. A first surface layer is laid on the first surface, wherein the first surface layer includes a first fiber material layer and a first resin material impregnated therein. A second surface layer is laid on the second surface, wherein the second surface layer includes a second fiber material layer and a second resin material impregnated therein. The first surface layer, the core layer, and the second surface layer are hot-pressed together so that a portion of the first resin material and a portion of the second resin material fill into each of the through holes, combing with each other, and forming a connecting column in each of the through holes.

In an embodiment, the first resin material and the second resin material each have a viscosity between 6000 cps and 70000 cps.

In order to make the aforementioned and other objects, features and advantages of the present invention comprehensible, several non-limiting embodiments accompanied with figures are described in detail below.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating the fabrication of a composite material according to the first embodiment of the present invention.

FIG. 2 is a cross-sectional view of the composite material according to the second embodiment of the present invention.

FIG. 3 illustrates the arrangement of the deflection test.

FIG. 4 shows the result of the deflection test 1.

FIG. 5 shows the result of the deflection test 2.

FIG. 6 shows the comparison between the mechanical properties of pure polycarbonate (PC) and a mixture of polycarbonate and recycle resin.

### DESCRIPTION OF EMBODIMENTS

Reference will now be made in detail to the embodiments of the invention, examples of which are illustrated in the accompanying drawings. Wherever possible, the same reference numbers are used in the drawings and the description to refer to the same or like elements.

In the present text, ranges defined by “a numerical value to another numerical value” are shorthand representations used to avoid listing all of the numerical values in the specification. Therefore, the recitation of a specific numerical range is equivalent to the recitation of any and all numerical values in that numerical range and discloses a smaller numerical range defined by any two numerical values in that numerical range, as is the case with said numerical value and said smaller numerical range being disclosed in the specification. For instance, recitation of “a dimension of 10 to 100 mm” discloses a range of “a dimension of 20 mm to 50 mm” regardless of whether other numerical values were cited in the specification.

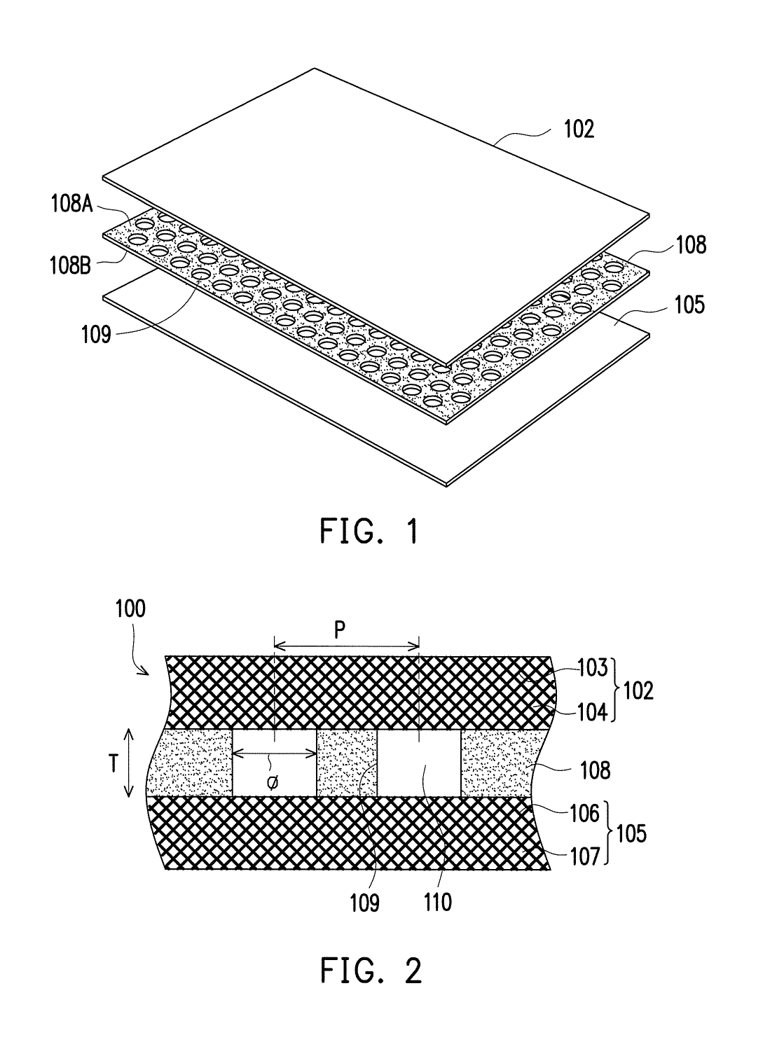

The first embodiment of the present invention is directed to a method of forming a composite material. FIG. 1 illustrates the fabrication of the composite material; in short, the fabrication of the composite material is a process of combining a first surface layer 102, a second surface layer 105, and a core layer 108.

Referring to FIG. 1, in this embodiment, the method of forming a composite material including the following steps. First, a core layer 108 is provided, wherein the core layer 108 has a first surface 108A and a second surface 108B opposite to each other and a plurality of through holes 109 each extending from the first surface 108A to the second surface 108B. The through holes 109 are formed by, for example, a punching process. To facilitate the formation of the composite material, the apertures of each of the through holes 109 and the thickness of the core layer 108 should better comply with certain relation, which will be described with reference to FIG. 2. Here, it is noteworthy that, the formation of the through holes 109 may help to reduce the overall weight of the composite material. Additionally, in this embodiment, the apertures of each of the through holes 109 are substantially the same, and in the core layer the through holes 109 are arranged in a honeycomb array, i.e., arranged in a hexagonal close-packed array. While the total weight is reduced by the formation of the through holes 109, the honeycomb arrangement may maintain the mechanical strength at a certain level.

The material of the core layer 108 is not particularly limited. It can include a metal or a polymer, as long as the through holes 109 can be fabricated therein. However, considering the purpose of reducing the weight of the composite material, the core layer 108 may have a specific weight that is less than those of the first surface layer 102 and the second surface layer 105. For example, the core layer 108 may include polycarbonate (PC), polyethylene terephthalate (PET), polymethyl methacrylate (PMMA), polyethylene (PE), acrylonitrile-butadiene-styrene (ABS), polyamide (PA), polypropylene (PP), polystyrene (PS), a metal, an artificial fiber, or a natural fiber. Additionally, if the core layer 108 is made from a thermoplastic resin (instead of a thermosetting resin), it may be beneficial for the recycling of the composite material, because the recycling of thermosetting resins usually involves the addition of chemical agents or other processes.

Referring back to FIG. 1, then, the first surface layer 102 is laid on the first surface 108A, and the second surface layer 105 is laid on the second surface 108B. A main portion of the first surface layer 102 may consist of a first fiber material layer, which is impregnated in advance. That is, the first surface layer 102 also includes a first resin material impregnated in the first fiber material layer. Similarly, the second surface layer 105 includes a second fiber material layer and a second resin material impregnated therein.

The material of each of the first fiber material layer and the second fiber material layer is not particularly limited, and can be, for example, a carbon fiber, a glass fiber, an artificial fiber, or a natural fiber. The material of each of the first resin material and the second resin material is not particularly limited too. It is noteworthy that, in the later hot-pressing process, the first resin material and the second resin material should be capable of flowing into the through holes 109, so that the first surface layer 102 and the second surface layer 105 can be combined together. In this regard, the first resin material and the second resin material may preferably have a viscosity between 6000 cps and 70000 cps, respectively.

Then, the first surface layer 102, the core layer 108, and the second surface layer 105 are hot-pressed together, so that a portion of the first resin material and a portion of the second resin material fill (flow) into each of the through holes 109, combining with each other, and forming a connecting column in each of the through holes 109 (please refer to FIG. 2 for a further understanding of this feature), thereby completing the fabrication of the composite material.

The second embodiment of the present invention is directed to a composite material, which may be obtained from the method of the first embodiment. The cross-sectional view of the composite material of the second embodiment is shown in FIG. 2, wherein the same element is indicated by the same numeral as used in FIG. 1.

Referring to FIG. 2, the composite material 100 includes the first surface layer 102, the second surface layer 105, and the core layer 108. The first surface layer 102 includes the first fiber material layer 103 and the first resin 104 impregnated therein. The second surface layer 105 includes the second fiber material layer 106 and the second resin 107 impregnated therein. The core layer 108 is disposed between the first surface layer 102 and the second surface layer 105, and has a plurality of through holes 109, wherein the first resin 104 and the second resin 107 penetrate into each of the through holes 109, combining with each other, and forming a connecting column 110 in each of the through holes 109.

The first surface layer 102, the first fiber material layer 103, the second surface layer 105, the second fiber material layer 106 and the core layer 108 may each have a material the same as that described in the first embodiment. As to the first resin 104 and the second resin 107, each of them may be composed of a material obtained from hot-pressing the first resin material and the second resin material in the first embodiment, respectively.

The thickness T of the core layer 108 may be between 0.1 mm and 1 mm. Note that, if the composite material 100 is formed by the method described in the first embodiment, then, for a better filling of the resin material into the through holes 109, the thickness T, the aperture φ of each of the through holes 109, and the pitch P of the through holes 109 should preferably be deliberately designed. Here, the pitch P refers to the shortest distance between the central axes of two adjacent through holes 109, as shown in FIG. 2. It is discovered that, the filling of the resin material would be much better as the pitch P is greater than the aperture φ and the aperture φ is greater than the thickness T; it is further discovered that, the filling of the resin material achieves the best result when φ≧T and P≧1.05φ.

-Experiments-

To demonstrate the effect of the above-described embodiments, the following examples are conducted. Although the following experiments are described, the materials used and the amount and ratio of the materials, as well as handling details and handling process . . . etc., can be modified without departing the scope of the invention. Accordingly, restrictive interpretation should not be made to the invention based on the experiment described below.

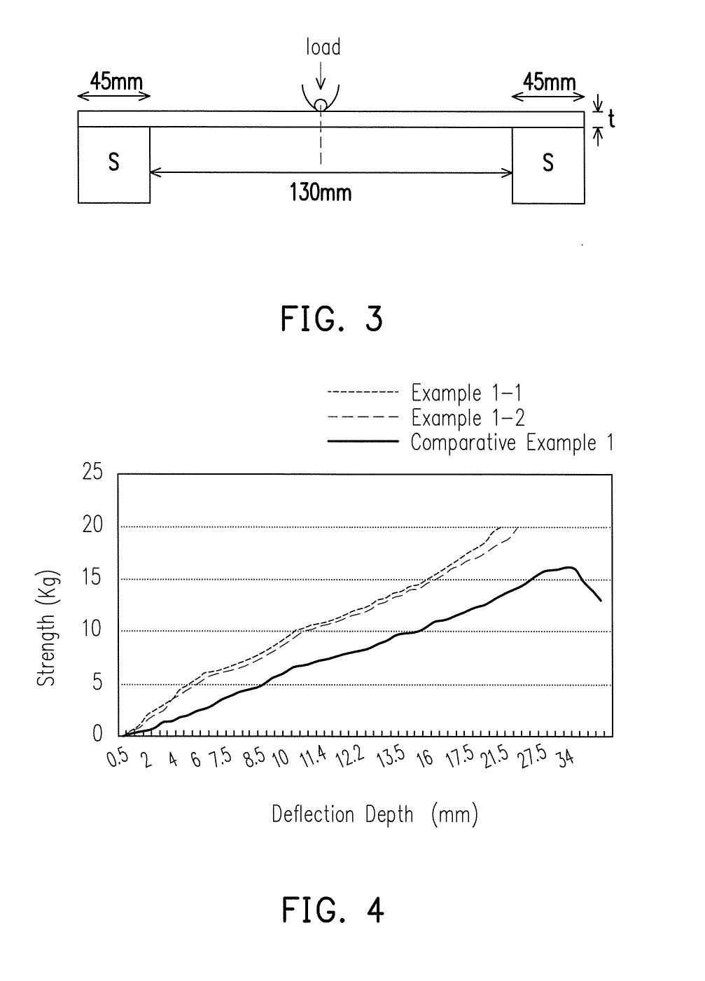

FIG. 3 illustrates a schematic diagram of the test arrangement of the deflection test. A sample with a thickness t and an area of 220×220 (mm²) is disposed on a support S, wherein a load is applied to its center. The deflection depth of the sample at a predetermined load and/or the maximum load the sample can withstand is recorded to evaluate the mechanical property of the sample.

Deflection Test 1

In this experiment, each of Examples 1-1 and 1-2 is a composite material. The surface layers of Example 1-1 are respectively a carbon fiber sheet impregnated with resin. The surface layers of Example 1-2 are respectively a carbon fiber sheet impregnated with resin too. A hot-pressing process is performed according to the method described in the first embodiment to combine the surface layers and the core layer. The composite material is disposed on the support S and the deflection test is performed. The result is shown in Table 1 and FIG. 4. In contrast, Comparative Example 1 is a chassis material made purely by carbon fibers.

TABLE 1

| | Example 1-1 | Example 1-2 | Comparative Example 1 |
|---|---|---|---|
| thickness t (mm) | 0.8 | 0.8 | 0.8 |
| weight (g) | 56 | 55 | 58 |
| 10 kg deflection (mm) | 8.9 | 9 | 13.5 |
| 20 kg deflection (mm) | 20.3 | 21.4 | 30 (16.2 kg) |

As can be seen from Table 1 and FIG. 4, with an identical thickness, Examples 1-1 and 1-2 each have a reduced weight (3.5% lower) and an improved strength (36% higher) as compared to Comparative Example 1. Note the carbon fiber sheet of the Comparative Example 1 is overly deflected and broken just as the load achieves 16.2 kg.

Deflection Test 2

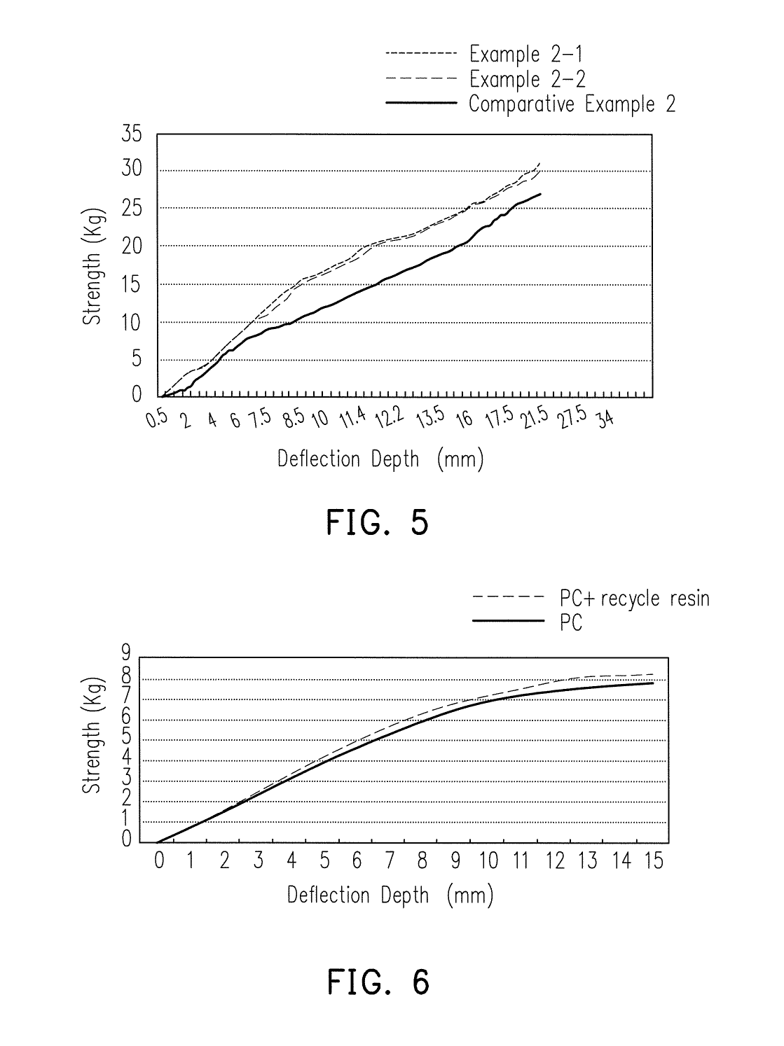

In this experiment, each of Examples 2-1 and 2-2 is a composite material. The surface layers of Example 2-1 are respectively a carbon fiber sheet impregnated with resin. The surface layers of Example 2-2 are respectively a carbon fiber sheet impregnated with resin too. A hot-pressing process is performed according to the method described in the first embodiment to combine the surface layers and the core layer. The composite material is disposed on the support S and the deflection test is performed. The result is shown in Table 2 and FIG. 5. In contrast, Comparative Example 2 is a chassis material made purely by carbon fibers.

TABLE 2

| | Example 2-1 | Example 2-2 | Comparative Example 2 |
|---|---|---|---|
| thickness t (mm) | 0.85 | 0.85 | 0.85 |
| weight (g) | 58 | 56 | 66 |
| 10 kg deflection (mm) | 5.4 | 5.4 | 7.5 |
| 20 kg deflection (mm) | 10.7 | 11 | 13.5 |

As can be seen from Table 2 and FIG. 5, due to the thickened thickness, the carbon fiber sheet of Comparative Example 2 can withstand a load of 20 kg. However, with an identical thickness, Examples 2-1 and 2-2 still have a reduced weight (12% lower) and an improved strength (28% higher) as compared to Comparative Example 2.

Example 1-2 and Example 2-2 both uses a thermoplastic resin as the material of the core layer, and that is more convenient in view of recycling. For example, the waste can be readily pulverized in the high speed mixer and then mixed with other resin material and reused. FIG. 6 shows the comparison between the mechanical properties of pure polycarbonate (PC) and a mixture of 80% polycarbonate and 20% recycle resin. As can be seen from FIG. 6, the mechanical properties of both samples are similar, and the mixture of polycarbonate and the recycle resin even has a slightly better performance.

Accordingly, the present invention provides a composite material and a method of forming the same. The composite material is suitable for manufacturing the chassis of notebook computer. The weight of the chassis may be reduced and the mechanical strength may be improved accordingly. As compared to the conventional chassis material, the present invention is superior in view of the cost and the feasibility of recycling.

The present invention has been disclosed above in the preferred embodiments, but is not limited to those. It is known to persons skilled in the art that some modifications and innovations may be made without departing from the spirit and scope of the present invention. Therefore, the scope of the present invention should be defined by the following claims.

What is claimed is:

1. A composite material, comprising:
a first surface layer, comprising a first fiber material layer and a first resin impregnated therein;
a second surface layer, comprising a second fiber material layer and a second resin impregnated therein; and
a core layer, disposed between the first surface layer and the second surface layer and having a plurality of through holes, wherein the first resin and the second resin penetrate into each of the through holes, combining with each other, and forming a connecting column in each of the through holes.

2. The composite material of claim 1, wherein a thickness of the core layer is between 0.1 mm and 1 mm.

3. The composite material of claim 1, wherein apertures of each of the through holes are substantially the same, and the through holes are arranged in a hexagonal close-packed array in the core layer.

4. The composite material of claim 3, wherein the aperture of each of the through holes is greater than a thickness of the core layer.

5. The composite material of claim 3, wherein a pitch of the through holes is greater than the aperture of each of the through holes.

6. The composite material of claim 1, wherein the core layer comprises a thermoplastic resin.

7. The composite material of claim 1, wherein the core layer comprises polycarbonate (PC), polyethylene terephthalate (PET), polymethyl methacrylate (PMMA), polyethylene (PE), acrylonitrile-butadiene-styrene (ABS), polypropylene (PP), polystyrene (PS), polyamide (PA), a metal, an artificial fiber, or a natural fiber.

8. The composite material of claim 1, wherein the first fiber material layer and the second fiber material layer respectively comprise a carbon fiber, a glass fiber, an artificial fiber, or a natural fiber.

9. A method of forming a composite material, comprising:
providing a core layer having a first surface and a second surface opposite to each other and a plurality of through holes each extending from the first surface to the second surface;
laying a first surface layer on the first surface, wherein the first surface layer comprises a first fiber material layer and a first resin material impregnated therein;
laying a second surface layer on the second surface, wherein the second surface layer comprises a second fiber material layer and a second resin material impregnated therein; and
hot-pressing the first surface layer, the core layer, and the second surface layer so that a portion of the first resin material and a portion of the second resin material fill into each of the through holes, combing with each other, and forming a connecting column in each of the through holes.

10. The method of claim 9, wherein the first resin material and the second resin material each have a viscosity between 6000 cps and 70000 cps.

11. The method of claim 9, wherein a thickness of the core layer is between 0.1 mm and 1 mm.

12. The method of claim 9, wherein apertures of each of the through holes are substantially the same, and the through holes are arranged in a hexagonal close-packed array in the core layer.

13. The method of claim 12, wherein the aperture of each of the through holes is greater than a thickness of the core layer.

14. The method of claim 12, wherein a pitch of the through holes is greater than the aperture of each of the through holes.

15. The method of claim 9, wherein the core layer comprises a thermoplastic resin.

16. The method of claim 9, wherein the core layer comprises polycarbonate (PC), polyethylene terephthalate (PET), polymethyl methacrylate (PMMA), polyethylene (PE), acrylonitrile-butadiene-styrene (ABS), polypropylene (PP), polystyrene (PS), polyamide (PA), a metal, an artificial fiber, or a natural fiber.

17. The method of claim 9, wherein the first fiber material layer and the second fiber material layer respectively comprise a carbon fiber, a glass fiber, an artificial fiber, or a natural fiber.
